(19) United States
(12) Patent Application Publication
(10) Pub. No.: US 2026/0229142 A1
(43) Pub. Date: Aug. 6, 2026

(54) SALES TRAINING NETWORK

(71) Applicant: Catherine Lowe, Buderim (AU)

(72) Inventor: Catherine Lowe, Buderim (AU)

(21) Appl. No.: 19/046,194

(22) Filed: Feb. 5, 2025

(51) Int. Cl. G09B 19/00; H04L 51/02

(52) U.S. Cl. CPC G09B 19/00; H04L 51/02

(57) ABSTRACT

A sales training network for training Users in sales has a community network software operably installed on the computer device, the community network software having a communications and training module for receiving a training request from each of the Users, whereby the user is able to select either AI assisted training, or to be matched with another of the Users. A matching component enables matching two of the Users in the event that the matching function is selected. A chatbot software generates a sales simulation, in the event that an AI simulation is selected. A feedback module is configured to evaluate the performance of the User, and to provide feedback for the User based on the evaluated sales performance of the User.

### BACKGROUND OF THE INVENTION

### Field of the Invention

This invention relates generally to sales training networks, and more particularly to an artificial intelligence (herein referred to as “AI”) assisted sales training network that enables a community of Users to organize and train, with both AI assistance and also by mutual in-person training, for the purposes of training in sales.

The system may include a communication training module that interacts with the User, who engages in sales training exercises to improve sales. The User may include trainees, participants, or any other individuals using the system for sales skill development.

### Description of Related Art

The prior art teaches a wide range of AI tools for assisting persons in receiving training, often with AI assistance. For example, Rini, U.S. 2018/0268341, teaches a network for the assessment, development, and management of the selling intelligence and sales performance of individual salespersons. The network supports 3D avatar based virtual reality that supports conversations and simulations that challenge the salesperson, as well as assessing the performance of the salesperson. The system supports automated coaching and feedback.

Another example includes, Leong, U.S. Pat. No. 12,165,633, which teaches a product for training a User to communicate in a subject area, in this case in the field of being an effective real estate agent. The product includes an output configured to provide a first communication output for presentation to the User to train the User to communicate in the subject area during a training session. The product includes an input configured to obtain a communication input representing or indicating a communication action performed by the User in response to the first communication output during the training session. A processing unit with a communication module then processes the communication input to determine a second communication output for presentation to the User, helping them practice communication in the subject area. Additionally, an evaluator assesses the User's communication performance and provides feedback based on the evaluation.

Another example of a similar system is shown in Burmeister, U.S. Pat. No. 11,095,773, which teaches a contextual lead generation system. The system may store information related to sales calls, and may identify strengths and weaknesses of a sales representative. The system may provide training content to the sales representative in real time based upon the identified strengths and weaknesses.

The prior art teaches various AI tools to assist in training, and to provide feedback to the Users. However, the prior art does not provide a comprehensive community that includes AI training, AI matched human-to-human training, and feedback, while also incorporating ranking, rewards systems, and job matching systems which synergize to encourage full use of the network for both individual and group development. The present invention fulfills these needs and provides further advantages as described in the following summary.

### SUMMARY OF THE INVENTION

The present invention teaches certain benefits in construction and use which give rise to the objectives described below.

The present invention provides a sales training network for training Users in commercial sales. The sales training network utilizes artificial intelligence to enable back and forth communication between a User and either another User, or an AI chatbot. An evaluator is configured to evaluate the communication performance of the User, and to provide feedback for the User based on the evaluated communication performance of the User. A rewards system is included for providing rewards to the User based upon the User achieving predetermined goals or achievements, and an AI-driven ranking system for determining and providing a rank to each of the Users, the rank being determined relative to other Users using the sales training network, or to established benchmarks of performance.

In some embodiments, the sales training network includes a community network software operably installed on the computer device, the community network software having a communications and training module for receiving a training request from each of the Users, whereby the user is able to select either AI assisted training, or to be matched with another of the Users. A matching component enables matching two of the Users in the event that the matching function is selected. A chatbot software generates a sales simulation, in the event that an AI simulation is selected. A feedback module is configured to evaluate the performance of the User, and to provide feedback for the User based on the evaluated sales performance of the User.

In some embodiments, the sales training network may further include a job board that includes a list of applicants and a list of potential jobs, each of the Users on the list of applicants including the rank determined by the AI-driven ranking system.

A primary objective of the present invention is to provide a sales training network having advantages not taught by the prior art.

Another objective is to provide a sales training network that includes AI-driven training processes and community network software that enables comprehensive training in commercial sales.

A further objective is to provide a sales training network that includes an AI-driven ranking system that may be posted to a job board after an applicant has gone through a training system of the network.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention.

FIG. 1 is a block diagram of a sales training network according to one embodiment of the present invention.

FIG. 2 is a flow diagram of the operation of chatbot software of the sales training network to enable AI-facilitated training to a User.

FIG. 3 is a flow diagram of the operation of a communications and training module of the sales training network to enable human-to-human training of the User.

FIG. 4 is a block diagram of a job board enabled by the sales training network.

FIG. 5 is an example of an applicant's profile posted to the job board and showing a rank of a ranking system.

### DETAILED DESCRIPTION OF THE INVENTION

The above-described drawing figures illustrate the invention, a sales training network for training Users in sales.

The present disclosure generally relates to artificial intelligence natural language processing technology, and machine perception technology, and more specifically to a chatbot and enhancing learning and professional training efficiencies utilizing a chatbot.

The present disclosure further relates to a network system that is adapted to building a community of salespeople to enable sales training, either via an AI chatbot trainer, or mutual training with each other.

The system may be executed using standard computer technology (e.g., keyboard, mouse), or it may be implemented using Perceptual User Interface (PUI) technology, which enables the computer system to track a User's movements and voice commands.

In a system and method in accordance with some embodiments, a computer system and software are designed to enable the system to engage in training activities via an AI chatbot working with one or more Users, without the presence of a human trainer. In another embodiment, the system and method may enable the inclusion of a human trainer in conjunction with AI systems, and it may enable interactions between multiple Users with each other, as part of a community of Users. The community may be based around certain desired skills and/or professions, and the community may be built by a trainer to support multiple Users in an AI assisted community.

In one embodiment, the sales skills being taught may include, for example, pre-qualifying a potential client, giving a product presentation, handling objections, closing skills, etc. Any sales skills known in the art may be incorporated into the current system, and alternative embodiments should be considered within the scope of the present invention.

In one embodiment, the training can be carried out by a chatbot software running in a computer system that can generate a communication with a human. The communication can take text, voice, or video as inputs. In some cases, the inputs may include rich media and/or sensor(s) data, including but not limited to input generated using hyperlink buttons, choice boxes, selection lists, virtual reality device, augmented reality device, etc.

There are four elements of a chatbot conversation. They are intent, utterances, entities, and stories. Intent is the speaker's intention over a text, audio or video sentence, and/or body language. Utterances are whatever the speaker says, types, or acts in realization of that intention. In any conversation, there can be more than one utterance per intent. For example, if the intent is to find out the current weather condition, an utterance can be “What is the weather like outside?” or “Is outside hot or cold?”. Oftentimes the tone and/or body language (or the change of tone, and/or change in body language) in a conversation may reveal a different intent or show the true intent. Entities are meta data about an intent. In the example above, “weather” and “outside” are the entities. Stories are dialog flows for the chatbot. For a given intent identified from an incoming utterance, together with its identified entities, a story determines how the chatbot should respond.

In a professional training situation such as training a salesperson, it is important that the salesperson has sufficient practice on how to handle the responses of a potential client or client to facilitate closing a business transaction. Such conversations may exemplify themselves with a multiple of different utterances against the same intent, and the tonal and gestural nature of the conversation may reveal whether the potential client is in doubt, frustrated or showing rapport and agreement. Most trainers have accumulated enough experience in handling such situations that they can teach the salesperson what is the best response for each situation. However, access to a human trainer is expensive and can be difficult to schedule, while access to an AI tool is inexpensive, and the AI tool may be accessed at any time and for any length of time. For example, a person may desire to squeeze training into a five-minute block of time while waiting in a line, and the AI tool will be available in a manner that would not be practical for a human trainer.

Also, the current invention also provides a network of other Users who are all seeking similar training. The network of the present invention enables Users to train with each other on their own schedules. Such networks of people may be actively built by a trainer who is skilled in training these skills, and the network enables the trainer to offer a wide range of tools so that his or her Users have access to a wide range of tools for their training.

For purposes of this application, the terms “computer,” “computer device,” “server,” and similar terms, refer to a device and/or system of devices that include at least one computer processor, and some form of computer memory having a capability to store data. The computer may comprise hardware, software, and firmware for receiving, storing, and/or processing data as described below. For example, a computer may comprise any of a wide range of digital electronic devices, including, but not limited to, a server, a desktop computer, a laptop, a smart phone, a tablet, or any form of electronic device capable of functioning as described herein.

The term “computer processor” as used herein refers to an electrical component that performs operations on an external data source, such as a computer memory, typically in the form of a microprocessor, although any equivalent structure may be used. The term “computer memory” as used herein refers to any tangible, non-transitory storage that participates in providing instructions to a processor for execution. Such a medium may take many forms, including but not limited to, non-volatile media, volatile media, and any equivalent media known in the art. Non-volatile media includes, for example, ROM, magnetic media, and optical storage media. Volatile media includes, for example, DRAM, which typically serves as main memory. Common forms of computer memory include, for example, hard drives and other forms of magnetic media, optical media such as CD-ROM disks, as well as various forms of RAM, ROM, PROM, EPROM, FLASH-EPROM, solid state media such as memory cards, and any other form of memory chip or cartridge, or any other medium from which a computer can read. While several examples are provided above, these examples are not meant to be limiting, but illustrative of several common examples, and any similar or equivalent devices or systems may be used that are known to those skilled in the art.

The term “database” as used herein, refers to any form of one or more (or combination of) relational databases, object-oriented databases, hierarchical databases, network databases, non-relational (e.g. NoSQL) databases, document store databases, in-memory databases, programs, tables, files, lists, or any form of programming structure or structures that function to store data as described herein.

The term “network” is defined to include any device or system for communicating information from one computer device to another. For example, a global computer network (e.g., the Internet) may be used, including any form of local area networks (LANs), wide area networks (WANs), direct connections, such as through a universal serial bus (USB) port, other forms of computer-readable media, or any combination thereof. On an interconnected set of LANs, including those based on differing architectures and protocols, a router may act as a link between LANs, enabling messages to be sent from one to another. In addition, communication links within LANs typically include twisted wire pair or coaxial cable, while communication links between networks may utilize analog telephone lines, full or fractional dedicated digital lines, Digital Subscriber Lines (DSLs), wireless links including satellite links, or other communications links known to those skilled in the art. The network may further include any form of wireless network, including cellular systems, WLAN, Wireless Router (WR) mesh, or the like. Access technologies such as 3G, 4G, 5G, and future access networks may enable wide area coverage for mobile devices. In essence, the wireless network may include any wireless communication mechanism known in the art by which information may travel between computers of the present system.

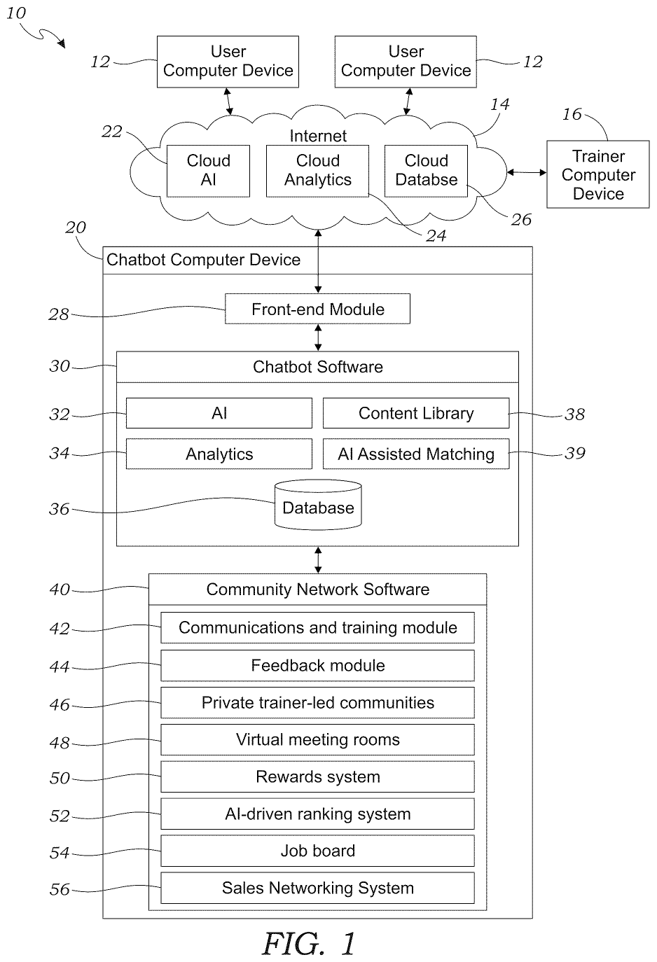

FIG. 1 is a block diagram of a sales training network 10 that is configured to provide training to a plurality of Users using User computers 12 to communicate with the sales training network 10. As shown in FIG. 1, the sales training network 10 may include chatbot software 30 in the form of a training software program operably installed on a chatbot computer device 20. The chatbot software 30 may be hosted on a server, or in the cloud accessed via a network 10 (e.g., the Internet).

As shown in FIG. 1, in this embodiment, the sales training network 10 may enable access by one or more User computer devices 12 (typically a large number of them), and may further allow access by at least one trainer computer device 16, so that Users and trainers may all interact with the network 10. The User computer devices 12 and the trainer computer device 16 may access the network 10 via the network 14.

In some embodiments, various components of the sales training network 10 may be located in the cloud, and accessed via techniques known in the art. In this embodiment, the sales training network 10 accesses a cloud AI 22, cloud analytics 24, and a cloud database 26.

Users of the sales training network 10 may access the chatbot computer device 20 via a front end module 28. The front end module 28 enables the Users to access any software on the chatbot computer device 20 to interface for dynamic User experiences. Operably installed on the chatbot computer device 20, in communication with the front end module 28, is chatbot software 30, which may also/alternatively include AI 32, analytics 34, and a database 36. Those skilled in the art may utilize either local software or cloud based options, depending upon their particular preferences.

The chatbot software 30 may also include a content library 38, which may include a variety of exemplary content which may assist the AI in instructing a User. Those skilled in the art can provide suitable scripts, formulas, and other materials that assist in training in a given skill. The device 20 may further include AI assisted matching 39, described in great detail below.

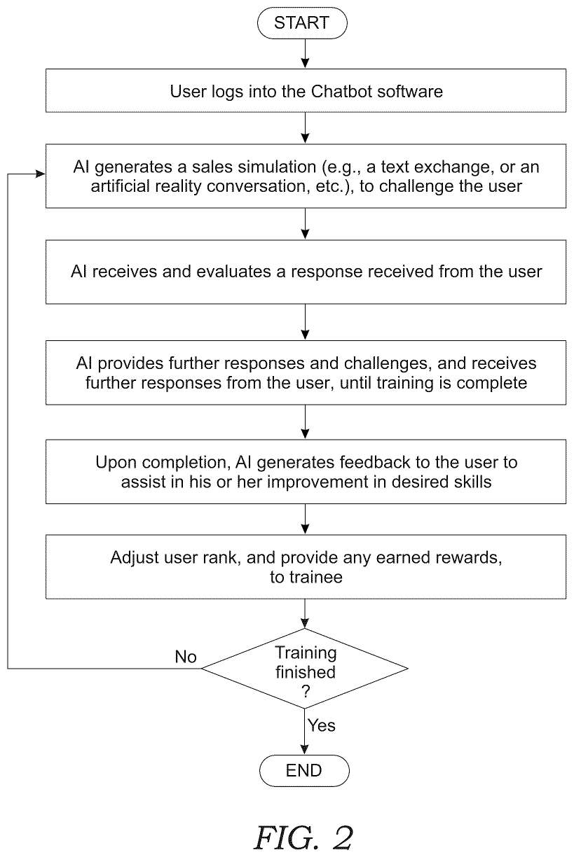

The chatbot software 30 is adapted to generate an output, the output being configured to provide a first communication output to the User to train the User in sales during a training session. The chatbot software 30 is also adapted to receive an input configured to obtain a communication input of a communication performed by the User in response to the first communication output during the training session. For training in communication skills, the chatbot software 30 can enable role-playing with the User, being able to play on either side of a communication. For communication that the User is expected to respond in certain professional manner, the chatbot 20 may play the counter-role with different configurable characters, mimicking a real-world situation. As discussed below, FIG. 2 shows an operation of the chatbot software 30, illustrating this function. By means of non-limiting examples, the chatbot software 20 may include natural language processing software, video analysis software for facial expression, gesture, and body language interpretations, machine perception, perceptual User interface (PUI), etc.

As shown in FIG. 1, the analytics software 34 is configured to process output from the chatbot software 20, communication input provided by the User during a training session, researched information regarding a certain subject area, and/or any of other types of information and/or data that may be helpful in implementing sales training for the User. The database 36 and content library 38 are configured to store information involved in the operation. The sales training network 10 may search the Internet 14 to obtain information relevant to sales training, and may utilize any such information when communicating outputs. By means of non-limiting examples, the information from the Internet 14 may be information from cloud AI 22, information from cloud analytics 24, information from cloud database 26, or any combination thereof.

The system 10 further includes a community network software 40 operably installed on the computer device 20, which includes a communications training module 42. The communications and training module 40 performs the following steps. It first receives a training request from each of the Users, and in turn provides a user interface to each of the Users which enables the User to select either AI assisted training, or to be matched with another of the Users. The User is then able to receive AI assisted training, if this is desired, without requiring any participation from any other users. This is particularly useful in the event that the User is on a tight schedule, can only train for a short period of time, or wants to train at odd hours, or while no other Users are available to train with. This enables training entirely at the whim of the User, and for as long or as short a period as desired.

In the event that the User desires training with another User, this may be selected, and the User may be matched with another User. This matching may be performed via any form of assisted matching, including but not limited to an AI assisted matching 39, which matches Users of suitable backgrounds (e.g., industries, skill levels, etc.). This enables the Users to simulate a sales conversation, which may be evaluated as discussed below.

If an AI simulation is requested, the chatbot software 30 may be used to simulate a sales process using AI. The chatbot software 30 may, for example, simulate a customer, request information about a product, respond to initial User inquiries (e.g., for qualifying the customer), raise objections, and perform any other steps that would assist in sales process training. In one embodiment, for example, the chatbot software 30 processes the communication input to determine a second communication output for presentation to the User to train the User in sales during the training session.

In one embodiment, the chatbot software 30 first prompts a large language model (an “LLM”) to generate a sales simulation between the chatbot software and the User. The software 30 obtains an output from the LLM, which is transmitted to the User, and then receives responses from the User to the outputs from the LLM. For example, initial information generated by the software 30 may be an inquiry into a product that the User is selling. The user would then respond with information about the product, the benefits of the product, how the product addresses a customer's needs and reduced consumer “pain,” and also testimonials, pricing information, and any other information suitable for a sales process.

The software 30 may raise objections and given any other suitable responses that would challenge the User, to determine how effectively the User is able to address these objections, provide requested information, and take any other actions that may be desirable in a sales process.

An evaluator may evaluate a sales performance of the User and provide feedback for the User based on the evaluated communication performance of the User. This may be integrated into the AI-driven ranking system 52, which determines and provides a rank to each of the Users, the rank being determined relative to other Users using the sales training network, or to other established benchmarks of performance. In the example of sales training, progress goals may be in the form of the number of cold calls, appointments, closing ratios per month etc. In some embodiments, the chatbot software 30 may be configured to remind the User on his/her progress, and recommend training session(s) to fill in any gap(s) in performance.

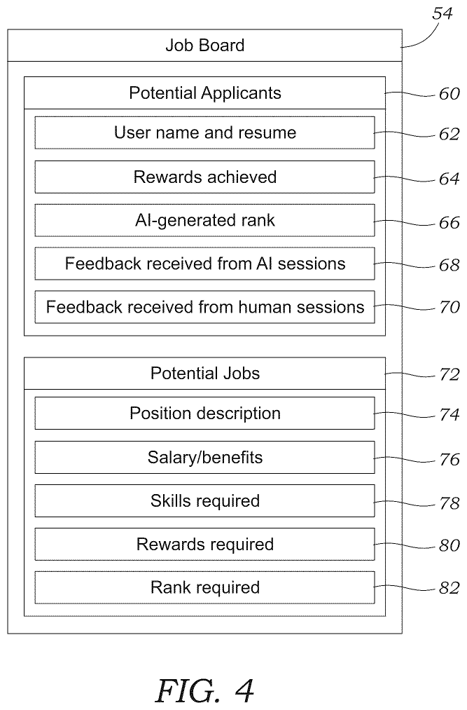

The evaluation may be sourced on the private trainer-led communities 46, or be sourced from cloud analytics 24, or any other suitable source. The rewards system 50 may be part of these processes, to incentivize Users. The rewards system 50 is for providing rewards to the User based upon the User achieving predetermined goals/achievements/benchmarks. In some embodiments, the rewards of the rewards system 50 are in the form of achievements, badges, numerical scores or grades, etc., which may be elements of the rank, and of a User profile, discussed further below. The ranking system 52 and job board 54 together synergistically facilitate hiring and encourage training. In various embodiments, the job board 54 includes a list of applicants and a list of potential jobs, each of the Users on the list of applicants including the rank determined by the AI-driven ranking system. An example of the job board 54 is shown in FIG. 4 and described further below.

In some embodiments, the system 10 may also be configured to be updated based on the information obtained from the Internet 14. In one implementation, certain rules may be set up such that if crawled information from the Internet 14 meets one or more criteria of such rules, an approval process may be triggered before the information is presented to the User. The approval process may involve an administrator or organization leader, and/or the trainer performing certain tasks to approve the information for updating the chatbot software 30 and/or the community network software 40 before presenting the information to the User. In some embodiments, it may be desirable for the sales training network 10 to provide a tool for enabling an easy onboarding for a trainer to create his or her own skills module. For example, the system, 10 may have a conversation upload module (not illustrated) configured to allow the trainer to upload sample training conversations in text, audio, video, sensor data, or any combination thereof. The trainer may also be enabled to upload his or her own recorded or authored conversations, training notes and User assignments in various file formats for Users, so that the AI 32 can reference it from the content library 38. As is typical for AI systems, the chatbot computer device 20 may utilize information from the Internet 14 (including the cloud AI 22, cloud analytics 24, and the cloud database 26), or from a human trainer's input as described above, or a combination of these. The training system 10 utilizes artificial neural networks to continuously update and optimize based on inputs from these informational sources, as well as feedback from the Users.

In addition, the administrator, owner, or leader of an organization may have a dashboard view of the training performance of the User and be able to map the business sales funnel (sales funnel information) and/or revenue that this User brings to the organization along a timeline. The trainer may view this via the community network software 40. This view allows a return of investment (ROI) evaluation of this chatbot software 30 when the owner of a business tries to scale up the operation by training more people.

Overall, the system 10 is adapted to enable professionals to enhance their skills through AI-driven role-playing, social networking, and collaborative training environments. Additional, not-illustrated features may be included, such as calendar management and scheduling features, which should be considered within the scope of the present invention.

It should be noted that the system 10 comprises a neural network model. The neural network model may be trained by machine learning based on a data set having a set of words associated with a communicational intent. The neural network model may be implemented via any types of neural networks (e.g., convolutional neural networks, deep neural networks). In some embodiments, the data output of the neural network model may be a numerical vector (e.g., a low dimensional numerical vector, such as embedding). The numerical vector may not be interpretable by a human, but may provide information regarding detected intent(s), detected meta data of intent(s), detected tone(s), and story/stories. In other embodiments, the data output of the neural network model may be any information indicating, representing, or associated with communicational intent, meta data of intent, tone, story, etc.

In some embodiments, the neural network model itself is a machine learning model. Thus, in come embodiments, the system 10 may include one or more machine learning models. Also, in some embodiments, the neural network model and/or another machine learning model may be configured to provide multiple metrics indicating respective probabilities of different intents based on the communication input. In such cases, the chatbot computer device 20 may be configured to select one of the intents with a corresponding metric indicating the highest probability. In such cases, the chatbot computer device 20 may be configured to determine the second communication output based on selected intent, and using an algorithm that comprises a set of pre-defined and/or data-driven rules associating different intents with pre-defined and/or data-driven responses.

It should also be noted that the system 10 is not limited to having a neural network model and/or other machine learning model to process User's communication, and that the chatbot computer device 20 may utilize any processing technique, algorithm, or processing architecture to determine what to communicate with the User. By means of non-limiting examples, the chatbot software 30 may utilize equations, regression, classification, heuristics, selection (e.g., from a library, graph, or chart), instance-based methods (e.g., nearest neighbor), correlation methods, regularization methods (e.g., ridge regression), decision trees, Baysean methods, kernel methods, probability, deterministics, or a combination of two or more of the above, to process User's communication to determine what to communicate with the User (e.g., what response or statement to provide to the User).

FIG. 2 is a flow diagram of the operation of chatbot software 30 of the sales training network 10 to enable AI-facilitated training to a User. As previously discussed, the chatbot software 30 generates the output, the output being configured to provide the first communication output to the User to train in sales during a training session. The software 30 further includes the input configured to obtain the communication input of the communication performed by the User in response to the first communication output during the training session.

As shown in FIG. 2, at the start of the operation, the User logs onto the chatbot software 30. The User or learner (Users) can access the software 30 via an application or browser on a smartphone, tablet, or computer. In some embodiments, the system 10 may provide an interface for allowing Users to login and/or to authenticate Users. In other embodiments, the Users may access the chatbot via a standard API such as RUST, or via some established social media channels' apps such as from Facebook, Microsoft Teams, X, Slack, etc. Also, in some embodiments, the Users may be authenticated via such social media channels using Open-Authentication. In some embodiments, the sales training network 10 may obtain information from the User's calendar to make sure there are regular training sessions, and/or may provide some assistance in scheduling an appointment with a client.

In the next step of the operation, AI 32 generates a sales simulation (e.g., a text exchange, or an artificial reality conversation, etc.), to challenge the User. The simulation may be generated by referencing the content library 38, database 36, and/or components of the internet 14. In various embodiments, the system 10 further comprises the processing unit comprising the communication module in the form of the community network software 40. The community network software 40 is configured to process the communication input to determine the second communication output for presentation to the User to train the User in sales during the training session. The User interface (communication module 42) may include text field, drop-down menu, check boxes, etc., for potentially allowing the trainer to input information regarding the key elements of the sales process; however, in alternative embodiments, the trainer may not have this capability.

As illustrated, AI receives and evaluates a response received from the User, then provides further responses and challenges and receives further responses from the User, until training is complete. Upon completion, AI generates feedback to the User to assist in his or her improvement in desired skills via the feedback module 44. Examples of feedback include metrics on tone, pacing, objection handling, closing techniques, etc. or any other form of feedback which may facilitate skills improvement in a professional environment, as determined by one skilled in the art. Feedback may also involve providing the User with resources (i.e., from the analytics 34 and content library 38) tailored to resolve performance gaps.

In some embodiments, the sales training network 10 may be configured to allow the User to upload information to a skills module such that it can enhance the training of the skills module. Examples of information may be recorded conversations with another human being, such as a client, wherein a recorded conversation may be text, audio, video, or any combination of the foregoing. The uploaded information may be used to configure the system 10 to set up a training session, to enhance a training session, and/or to allow evaluation of the recorded conversations. Also, in some embodiments, the chatbot software 30 may be configured to add new utterances for each given intent, and enables role-play training in various roles with the User without involving a live trainer.

After feedback is provided, the User rank is adjusted, and any earned rewards are provided to the User. Finally, the software 30 evaluates whether the training is complete, and ends the process if so. If further training is needed, the software 30 generates another sales simulation, and repeats the process from there. During this operation, the chatbot computer device 20, and its included software 30 and 40, utilizes natural language processing (NLP) for dynamic interaction, as well as machine learning (ML) algorithms for scoring and adaptive feedback.

In some embodiments, the User may have the ability to share his or her information (evaluations, comments, rewards, rankings, etc.) publicly, or to maintain this information privately, or to share it only with particular groups but not others (e.g., employers but not other Users).

It should be noted that other techniques for scoring may be employed by the product. In one example, the evaluator may take into account other parameters when evaluating a performance of a User. For example, in other embodiments, instead of, or in addition to, tracking outcome of a communication topic, the evaluator may determine a User's tonality, gestures, etc., and determine a score based on one or more of these parameters. In some cases, if the User exhibited calm and confident tonality along with good gestures indicating good rapport, then the evaluator may provide higher score for such User. In some embodiments, the system 10 may include a speech analyzer to determine tonality, and may also include pose identifier to determine one or more gestures of a User.

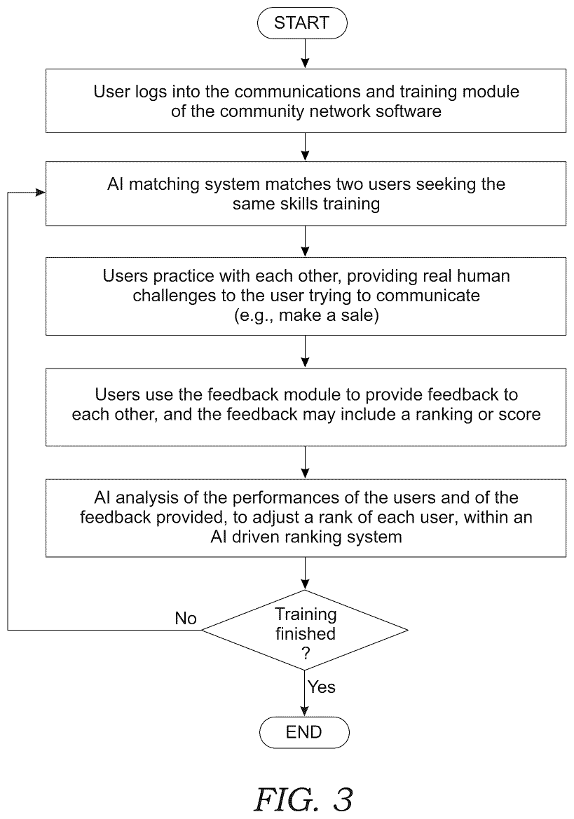

FIG. 3 is a flow diagram of the operation of a communications and training module of the sales training network to enable human-to-human training of the User. At the start of the operation, the User logs into the communications and training module 42 of the community network software 40, wherein the AI matching system 39 matches two Users seeking the same skills training. The AI matching system 39 may suggest ideal practice partners or groups based on skill level and goals. Next, the Users practice with each other, providing real human challenges to the User to help them develop their sales skills. The Users engage with the feedback module 44 to provide feedback to each other, and the feedback may include a ranking or score. AI analyzes the performance of the Users and the feedback provided to adjust a rank of each User within the AI-driven ranking system 52. If the module 42 determines the training is finished, the operation concludes, but if the module 42 determines that further training is needed or desired, the AI matching system matches two Users again (the same Users, or a new pairing), and repeats the above-described operation.

In some embodiments, the chatbot computer device 20 may optionally comprise a recorder configured to record the interaction. In some embodiments, the interaction comprises an audio conversation between the User using the chatbot software 30 and/or the community network software 40, and the recorder is configured to record the conversation in audio form. In other embodiments, the interaction comprises a text conversation, and the recorder is configured to record the conversation in text form. In further embodiments, the interaction comprises a gesture or a body pose performed by the User, and the recorder is configured to record the interaction in video form. The recorder may be configured to process data of the interaction between the User and the chatbot computer device 20, and provide the processed data to the non-transitory medium for storage in the database 36. Also, in some embodiments, the computer device 20 may optionally also comprise a playback module configured to playback the recorded interaction.

In some embodiments, the feedback module 44 may be configured to provide feedback information indicating a communication area that needs improvement, and/or a suggestion regarding a next communication training session. In some embodiments, the feedback module 44 is configured to provide the feedback information based on an evaluation result provided by the evaluator. For example, the evaluator may determine that the User needs further practice or training in a certain skill or element of the sales process. In such cases, the feedback module may provide feedback information to the User based on such evaluation result. For example, the feedback module 44 may send a message (audio and/or text message) informing the User that the certain topic or sub-topic needs to be worked on further. The report may be stored in the database 36, and may be accessible by the User and/or the trainer after logging in. In some cases, the report may provide specific details regarding the area(s) that need to be worked on by the User. In some embodiments, the report may also provide a video and/or audio of the recorded communication between the User and the device 20. The video and/or the audio may include a time-bar with one or more markers identifying event(s) of interest that is relevant for the evaluation. For example, there may be a marker (e.g., a graphic, such as an object, a flag, etc.) at time=2:34 minute of the time bar. When the User select the marker, the report may provide additional details about the event. For example, the report may indicate that at time=2:34, the User exhibited an unfriendly gesture, responded inappropriately, had an unwelcome facial expression, etc. In addition, in some embodiments, the feedback module 44 may be configured to determine and provide a recommendation for an action (e.g., next best action) for the User and/or the trainer.

In use, the communications and training module 42 has the sales networking system 26 which enables Users connect with other professionals in the field to share tips and resources. This includes the virtual meeting rooms 48, and may further include peer-to-peer scheduling for live role-playing sessions, networking feeds to post achievements, insights, or questions, group forums, direct messaging UI, private communities for trainers and corporate teams, User profiles for showcasing resumes, rank, portfolio, rewards earned, goals, etc. Groups may be formed based on industries, companies, interests, or other criteria. The module 42 may include an admin dashboard for trainers to monitor group engagement and progress via the trainer computer device(s) 16.

FIG. 4 is a block diagram of a job board 54 enabled by the sales training network. As illustrated, the job board 54 may be integrated into the community network software 40 of the chatbot computer device 20. The job board 54 may include results from the ranking system 52 derived from the operation of FIGS. 2-3. The job board 54 may be accessed via the User computer device(s) 12 and/or the trainer computer device 16, and may further be accessed by multiple different companies and remote computers, to facilitate hiring and promotion processes.

As shown in FIG. 4, the job board 54 includes a potential applicants element 60 (i.e., list, page, etc.) so that a hiring manager may view applicants for a particular position, or for general hire. Element 60 may include User name and resume 62, rewards achieved 64, AI-generated rank 66 (from the ranking system 52), and feedback received from AI sessions 68 and feedback received from human sessions 70 from the feedback module 44. In this manner, a hiring manager (who may use AI systems or similar modules for analyzing potential applicants 60) can compare applicants 60 against a potential jobs element 72 for finding suitable candidates for open company positions.

In this embodiment, the potential jobs element 72 functions as a job listing application/web page for a professional seeking open company positions. Element 72 may include a position description 74, salary/benefits 76, skills required 78, rewards required 80, rank required 82, and any other relevant information that should be included in a job listing, such as full/part time, onsite/remote location, etc. In use, the job board 54 assists Users of the training system 10 with finding job opportunities and showcasing skills and feedback verified by the system 10. The job board 54 may be accessible to a wide range of Users, from different departments, companies, and at different tiers of leadership.

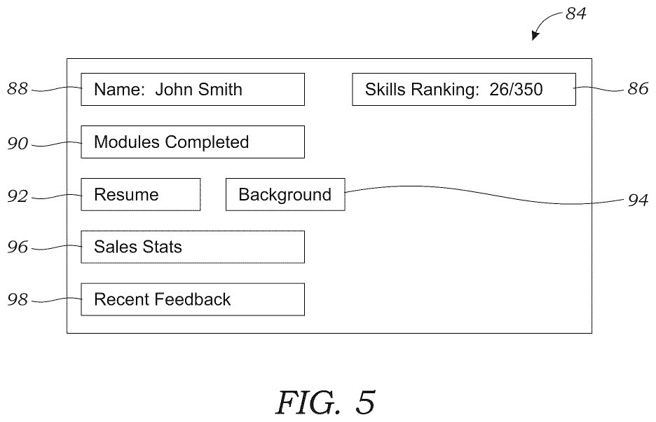

FIG. 5 is an example of an applicant's profile 84 posted to the job board 54 and showing a rank 86 of the ranking system 52. As shown in FIG. 5, the applicant profile 84 may further include applicant name 88, modules completed 90 (from training), resume 92, background (personal info, etc.) 94, sales stats 96, recent feedback 98, or any other details desired for an applicant profile, as needed for obtaining different types of positions in a given field. In some embodiments, the rank is gamified with levels of difficulty, and the rewards system 50 is integrated similar to a video game, with badges, networking milestones, etc., or similar. While an example ranking 86 of 26/350 is illustrated, any representation of rank may be included. For example, the rank 86 may represent different progress levels such as 1-6 (or similar), or it may be displayed as relative to other Users who have applied for the position. The ranking 86 may be numerical as shown, or it may instead be shown as “rank D1” or similar, or other means of display, as long as the hiring manager can understand the rank achieved by progress through training.

The title of the present application, and the claims presented, do not limit what may be claimed in the future, based upon and supported by the present application. Furthermore, any features shown in any of the drawings may be combined with any features from any other drawings to form an invention which may be claimed.

As used in this application, the words “a,” “an,” and “one” are defined to include one or more of the referenced item unless specifically stated otherwise. The terms “approximately” and “about” are defined to mean +/−10%, unless otherwise stated. Also, the terms “have,” “include,” “contain,” and similar terms are defined to mean “comprising” unless specifically stated otherwise. Furthermore, the terminology used in the specification provided above is hereby defined to include similar and/or equivalent terms, and/or alternative embodiments that would be considered obvious to one skilled in the art given the teachings of the present patent application. While the invention has been described with reference to at least one particular embodiment, it is to be clearly understood that the invention is not limited to these embodiments, but rather the scope of the invention is defined by claims made to the invention.

What is claimed is:

1. A sales training network for training Users in sales, the sales training network comprising:
a computer device having a computer processor and a computer memory;
community network software operably installed on the computer device, the community network software having a communications and training module for receiving a training request from each of the Users, whereby the user is able to select either AI assisted training, or to be matched with another of the Users;
a matching component for matching two of the Users in the event that the matching function is selected;
a chatbot software operably installed on the computer device which, in the event that AI assisted training is selected with generate a sales simulation;
a feedback module configured to evaluate the performance of the User, and to provide feedback for the User based on the evaluated sales performance of the User.

2. The sales training network of claim 1, further comprising an AI-driven ranking system for determining and providing a rank to each of the Users, the rank being determined relative to other Users using the sales training network, or to established benchmarks of performance.

3. The sales training network of claim 1, further comprising a job board that includes a list of applicants and a list of potential jobs, each of the Users on the list of applicants including the rank determined by the AI-driven ranking system.

4. A sales training network for training Users in sales, the sales training network comprising:
a computer device having a computer processor and a computer memory;
community network software operably installed on the computer device, the community network software having a communications and training module for performing the following steps:
receiving a training request from each of the Users; and
providing a user interface to each of the Users which enables the User to select either AI assisted training, or to be matched with another of the Users;
a matching component of the community network software is provided for matching two of the Users in the event that the matching function is selected, to enable the users to simulate a sales conversation;
a chatbot software operably installed on the computer device, the chatbot software performing, in the event that AI assisted training is selected by the User, the following steps:
prompting an LLM to generate a sales simulation between the chatbot software and the User;
obtaining an output from the LLM;
transmitting the output from the LLM to the User; and
receiving responses from the User to the outputs from the LLM; and
a feedback module configured to evaluate the performance of the User, with either the matched User or the chatbot software, and to provide feedback for the User based on the evaluated sales performance of the User.

5. The sales training network of claim 4, further comprising an AI-driven ranking system for determining and providing a rank to each of the Users, the rank being determined relative to other Users using the sales training network, or to established benchmarks of performance.

6. The sales training network of claim 4, further comprising a job board that includes a list of applicants and a list of potential jobs, each of the Users on the list of applicants including the rank determined by the AI-driven ranking system.

7. A sales training network for training Users in sales, the sales training network comprising:
a computer device having a computer processor and a computer memory;
community network software operably installed on the computer device, the community network software having a communications and training module for performing the following steps:
receiving a training request from each of the Users; and
providing a user interface to each of the Users which enables the User to select either AI assisted training, or to be matched with another of the Users;
a matching component for matching two of the Users in the event that the matching function is selected, to enable the users to simulate a sales conversation;
a chatbot software operably installed on the computer device, the chatbot software performing, in the event that AI assisted training is selected by the User, the following steps:
prompting an LLM to generate a sales simulation between the chatbot software and the User;
obtaining an output from the LLM;
transmitting the output from the LLM to the User; and
receiving responses from the User to the outputs from the LLM; and
a feedback module configured to evaluate the performance of the User, with either the matched User or the chatbot software, and to provide feedback for the User based on the evaluated sales performance of the User;
an AI-driven ranking system for determining and providing a rank to each of the Users, the rank being determined relative to other Users using the sales training network, or to established benchmarks of performance; and
further comprising a job board that includes a list of applicants and a list of potential jobs, each of the Users on the list of applicants including the rank determined by the AI-driven ranking system.
